(19) United States
(12) Patent Application Publication
(10) Pub. No.: US 2009/0265652 A1
(43) Pub. Date: Oct. 22, 2009

(54) MACHINE TOOL AND SOFTWARE MAGNIFIER OPERATING METHOD THEREOF

(75) Inventors: CHIEN-CHUNG WU, Tu-Cheng (TW); FEI-HSU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/329,613

(22) Filed: Dec. 7, 2008

(30) Foreign Application Priority Data
Apr. 18, 2008 (TW) 97114130

(51) Int. Cl. G06F 3/048

(52) U.S. Cl. 715/771

(57) ABSTRACT

A software magnifier operate method of a machine tool includes selecting a magnifier image button on an operate interface to execute a software magnifier program. A first position of the operate interface is selected for magnifying the first position into a first magnify area. A second position of the operate interface is selected for magnifies the second position into a second magnify area, and the first magnify area is closed simultaneously.

### BACKGROUND

1. Technical Field

The invention relates to operation of a machine tool, and more particularly to a machine tool and software magnifier operate method thereof.

2. Description of Related Art

Machine tools such as a computerized numerical control (CNC) machine tool or an injection molding machine tool have recently made use of computerized numerical control technology. The machine tool uses a CNC system to control movement of the machine tool and movement of a workpiece. Current demands on the machine tool system include increased functionality, reduced volume of the computer and driving equipment, and improved calculation accuracy. Operate function technology is thus important in the machine tool.

A typical machine tool includes a display unit which displays a main operate interface having a select area, a parameter area, and a message area, all of which correspond to each other. The select area displays a plurality of select buttons, and the parameter area lists a plurality of parameter values, and the message area displays a plurality of word messages or images.

However, the select area needs to display a large number of the select buttons, each of which corresponds to a large number of the parameter values. When one of the select buttons is selected, the main operate interface does not clearly display all of the corresponding parameter values and the corresponding word messages. Therefore, the words or the images on the main operate interface needs to be reduced. However, users who operate the machine tool always cannot see the words or the images clearly. In addition, the frame of the display unit 11 is too small for users to operate and look at the main operate interface.

### BRIEF DESCRIPTION OF THE DRAWINGS

FIG. 1 is a block diagram of hardware structure of one embodiment of a machine tool.

FIG. 2 is a schematic view of the machine tool of FIG. 1 showing an operate interface.

FIG. 3 is a schematic view of a first position, a second position and a third position of the operate interface of the machine tool of FIG. 1.

FIG. 4 is a schematic view of the operate interface of the machine tool of FIG. 1 showing a first magnify area and the second position.

FIG. 5 is a schematic view of the operate interface of the machine tool of FIG. 1 showing a second magnify position.

FIG. 6 is a schematic view of a set time interface of the machine tool of FIG 1.

FIGS. 7A, 7B are flowcharts of one embodiment of a software magnifier operate method for the machine tool.

FIG. 8 is a flowchart of one embodiment of a display time operate method for the machine tool.

### DETAILED DESCRIPTION

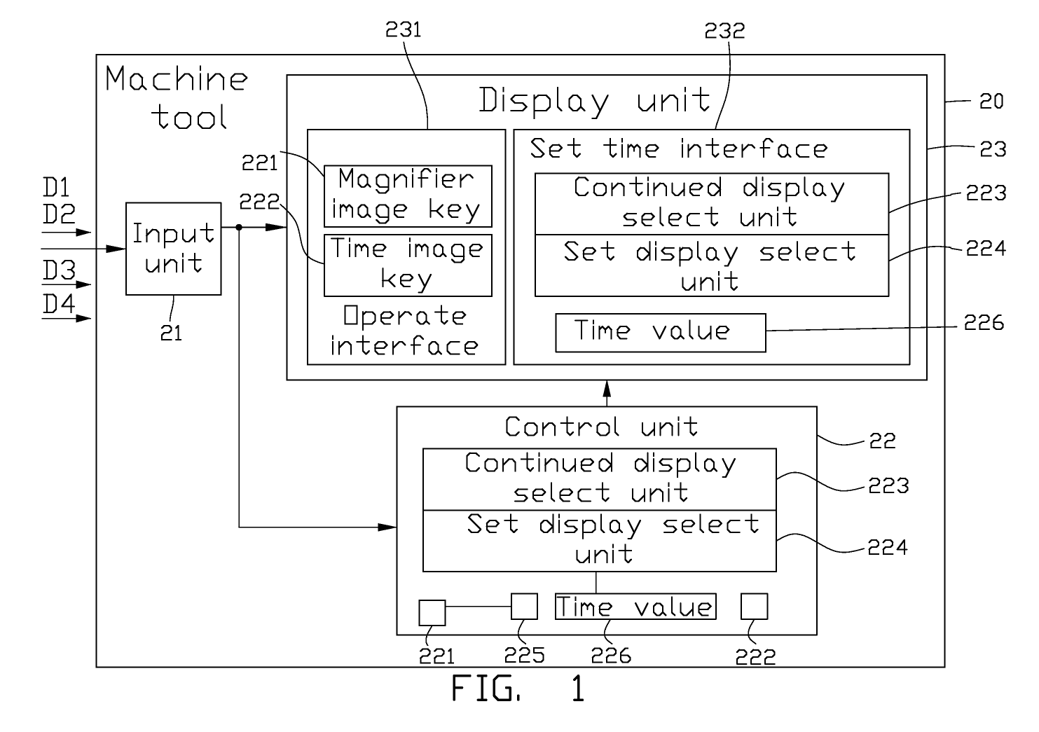

Referring to FIG. 1, one embodiment of a machine tool 20 includes an input unit 21, a control unit 22, and a display unit 23. For example, the machine tool 20 may be a numerical control machine tool, a computerized numerical control (CNC) machine tool, or an injection molding machine tool.

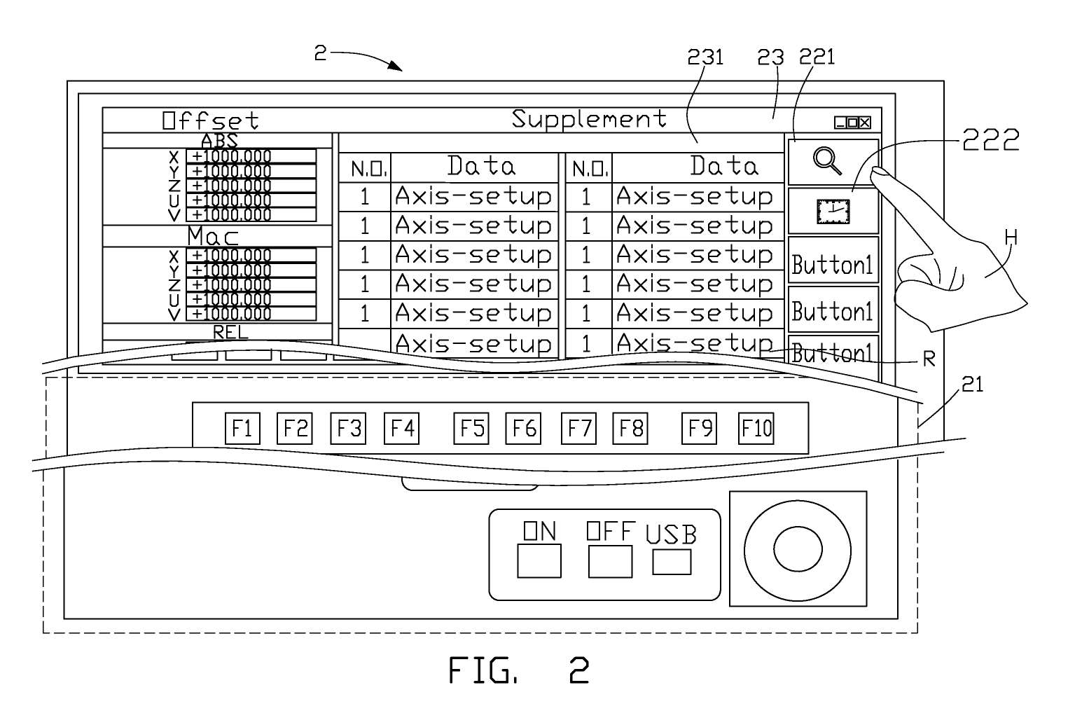

In one embodiment, the input unit 21 receives and transmits a first input instruction D1, a second input instruction D2, a third input instruction D3, and a fourth input instruction D4 to the control unit 22. Input methods of the first input instruction D1, the second input instruction D2, the third input instruction D3 and the fourth input instruction D4 may be inputted from outside of the machine tool 20, by a finger H, a button, or a keyboard (as shown in FIG. 2).

Referring also to FIG. 2, the control unit 22, which is coupled with the input unit 21, includes a magnifier image button 221, a time image button 222, a continued display select unit 223, and a set display select unit 224. In addition, the control unit 22 may also store a software magnifier program 225 and a time value 226.

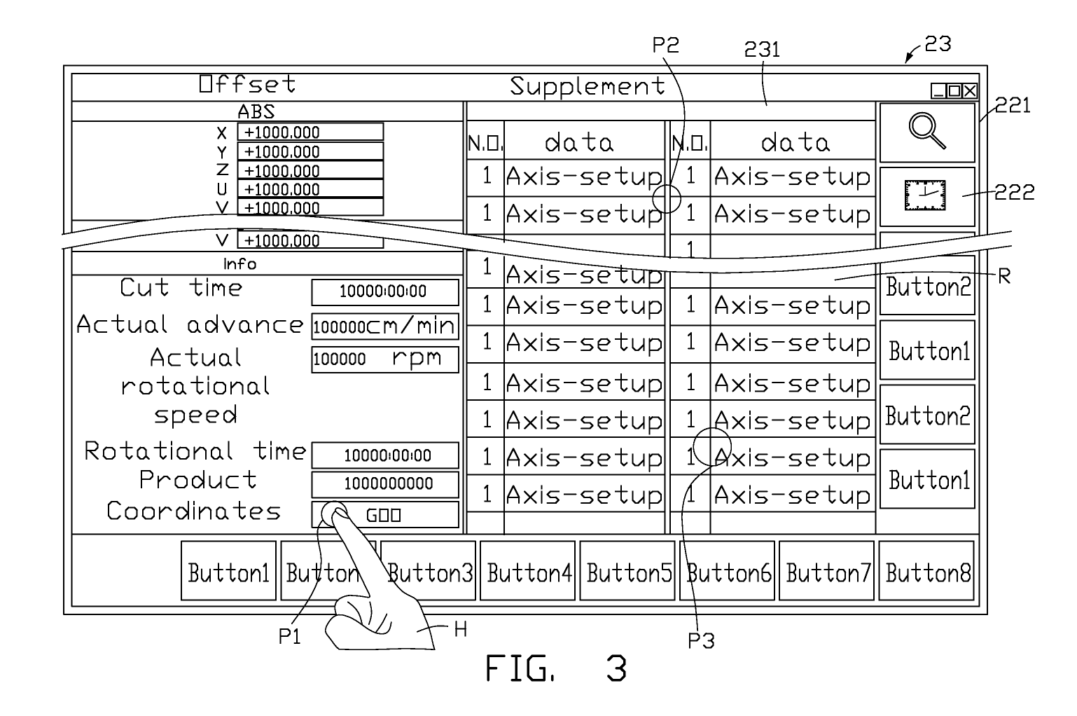

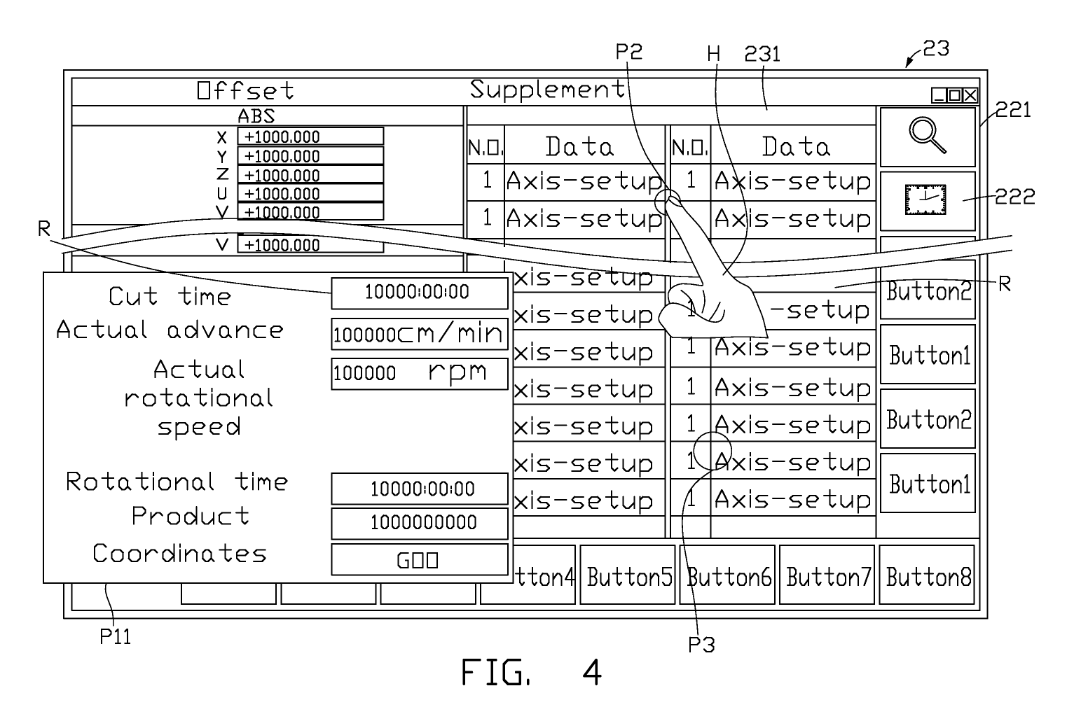

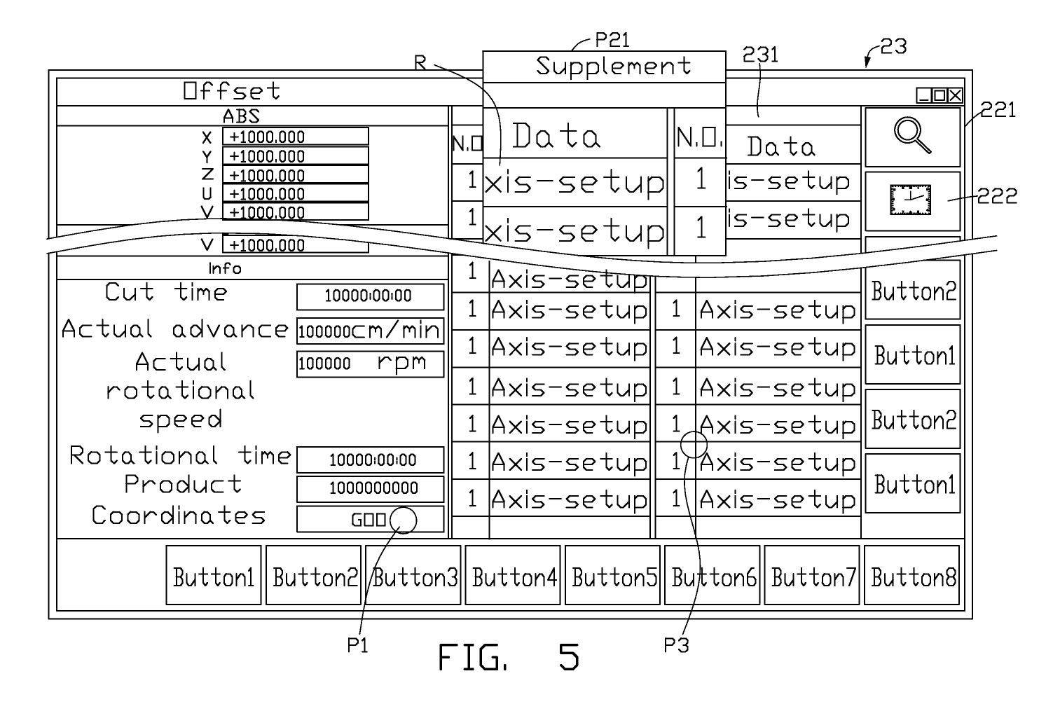

The control unit 22 opens or closes the magnifier image button 221 according to the first input instruction D1, as shown in FIG. 1 through FIG. 5. Referring to FIG. 3 and FIG. 4, the control unit 22 selects and magnifies a first position P1 into a first magnify area P11. Referring to FIG. 4 and FIG. 5, the control unit 22 selects and magnifies a second position P2 into a second magnify area P21, or selects and magnifies a third position P3 into a third magnify area.

After the control unit 22 selects and magnifies the first position P1 into the first magnify area P11 according to the second input instruction D2, the control unit 22 selects the second position P2 according to the second input instruction D2. The first magnify area P11 is closed as the second position P2 is magnified into the second magnify area P21 as shown in FIG. 3 through FIG. 5. When the control unit 22 selects the third position P3, the second magnify area P21 is closed as the third position P3 is magnified into the third magnify area. In other words, when the control unit 22 selects a position according to a subsequent input instruction, the preceding magnified area is closed as the selective position is magnified.

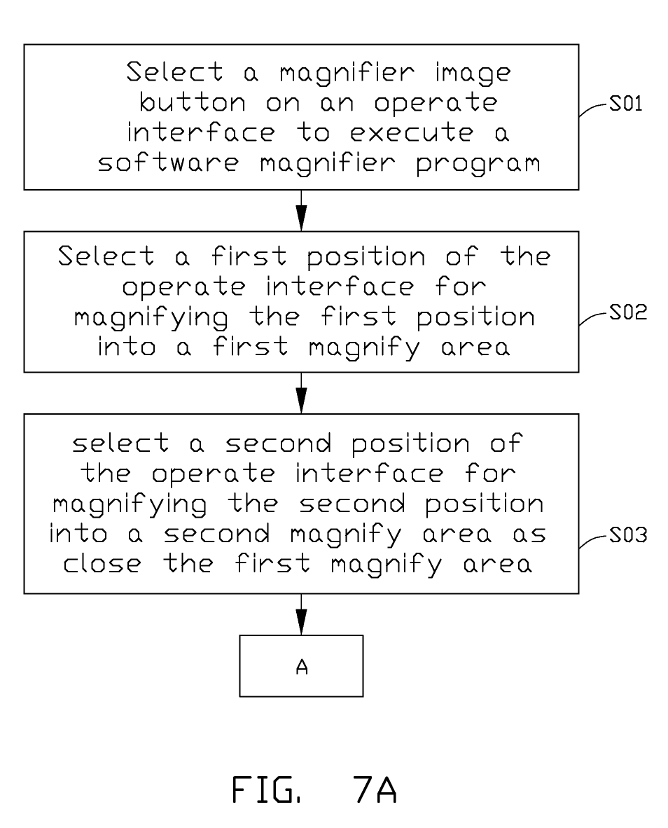

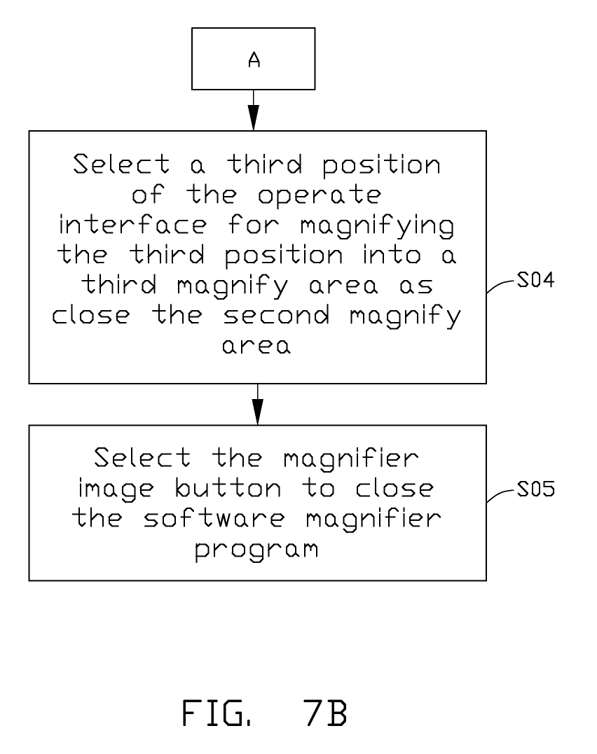

Referring to FIG. 7, the control unit 22 opens or closes the time image button 222 according to the third input instruction D3. The control unit 22 selects and executes the continued display select unit 223 or the set display select unit 224 according to the fourth input instruction D4. When the continued display select unit 223 is selected, the control unit 22 executes a magnify display function continuously. When the set display select unit 224 is selected, the control unit 22 sets and accords with the time value 226 to execute a set time function. In one embodiment, the time value 226 is set from outside of the machine tool 20 and is set according to different demands. For example, the control unit 22 selects the set display select unit 224, and the time value 226 is set to 30 seconds.

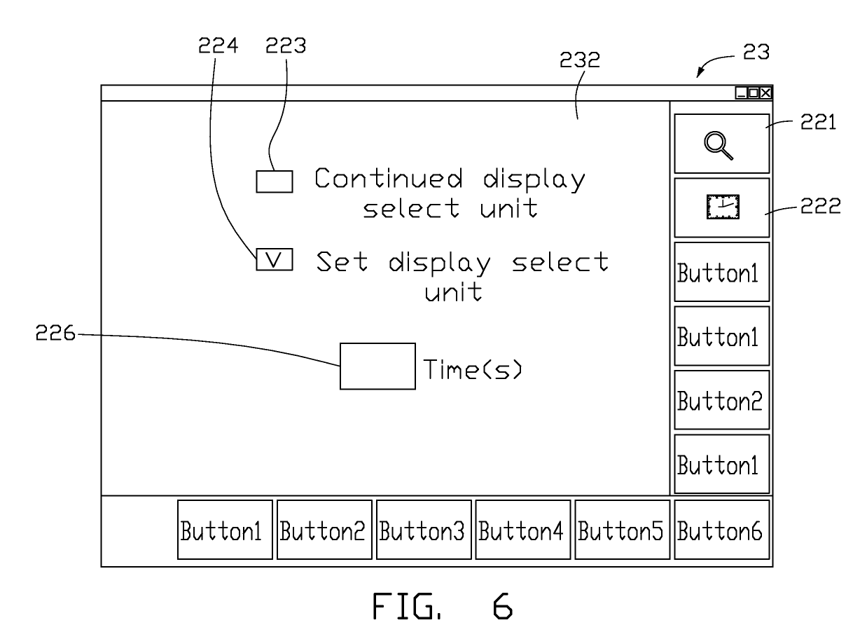

In one embodiment, the display unit 23, which is coupled with the input unit 21 and the control unit 22, displays an operate interface 231 as shown in FIG. 2 through FIG. 5 or a set time interface 232 as shown in FIG. 6. The operate interface 231 displays the magnifier image button 221 and the time image button 222. Referring to FIG. 6, the set time interface 232 lists the continued display select unit 223 and the set display select unit 224. For example, the display unit 23 is a touch control display. Therefore, the first input instruction D1, the second input instruction D2, the third input instruction D3 and the fourth input instruction D4 in accordance with the different demands to be inputted through the display unit 23 to the input unit 21. Furthermore, the position P1, the second position P2, and the third position P3 can be any different positions of the operate interface 231, and each displays a plurality of parameter values R which change in real time, such as words or images. For example, the position P1, the second position P2, and the third position P3 display a plurality of parameter values R.

For example, as shown in FIG. 1 and FIG. 2, the display unit 23 of the machine tool 20 may be a touch control display. When a software magnifier function of the machine tool 20 is executed, the machine tool 20 is operated and set directly on the display unit 23 by a finger H.

When the machine tool 20 is operated, the time image button 222 may be selected to set the time value of any position for displaying continuously or displaying a span and closing as the input unit 21 receives the first input instruction D1 to the control unit 22. The control unit 22 opens the time image button 222 according to the first input instruction D1, and the set time interface 232 is displayed on the operate interface 231, as shown in FIG. 6.

For example, the set display select unit 224 of the set time interface 232 is selected, and the time value 226 is set to 30 seconds. The control unit 22 receives the third input instruction D3 through the input unit 21 and executes the window magnify function by the time value 226. After the set display select unit 224 has finished, the time image button 222 is selected again to close the set time interface 232.

In one example as shown in FIG. 2 and FIG. 3, the magnifier image button 221 is selected, and the control unit 22 receives and accords with the first input instruction D1 to execute the software magnifier function. The first position P1 which has the parameter values R is selected, as shown in FIG. 3. The control unit 22 magnifies the first position P1 to the first magnify area P11 according to the second input instruction D2. The parameter values R of the first magnify area P11 can change in real time, and the first magnify area P11 is closed automatically after 30 sec. If the first position P1 is selected again, the first position P1 again is magnified into the first magnify area P11. If the user wants to see another position such as the second position P2, the user selects the second position P2, and the first magnify area P11 is closed as the second position P2 is magnified to the second magnify area P21 as seen in FIG. 4 and FIG. 5.

In one embodiment, the machine tool 20 adds the magnifier image 221 which magnifies the words or the images and displays the words or the image, each of which change in real time. Thus, the machine tool 20 not only decreases the fatigue strength of the eyes, but also increases the convenience, friendly operation, and work efficiency.

Referring to FIGS. 7A and 7B, one embodiment of the magnifier operating method of the machine tool 20, is shown. Depending on the embodiment, certain of the steps described below may be removed, others may be added, and the sequence of steps may be altered.

In step S01, a magnifier image button on an operate interface is selected to execute a software magnifier program.

In step S02, a first position of the operate interface is selected for magnifying the first position into a first magnify area, as shown in FIG. 3 and FIG. 4.

In step S03, a second position of the operate interface is selected for magnifying the second position into a second magnify area as the first magnify area is closed, as shown in FIG. 3 to FIG. 5.

In step S04, a third position of the operate interface is selected for magnifying the third position into a third magnify area, as the second magnify area is closed, as shown in FIG. 3.

In step S05, the magnifier image button is selected to close the software magnifier program.

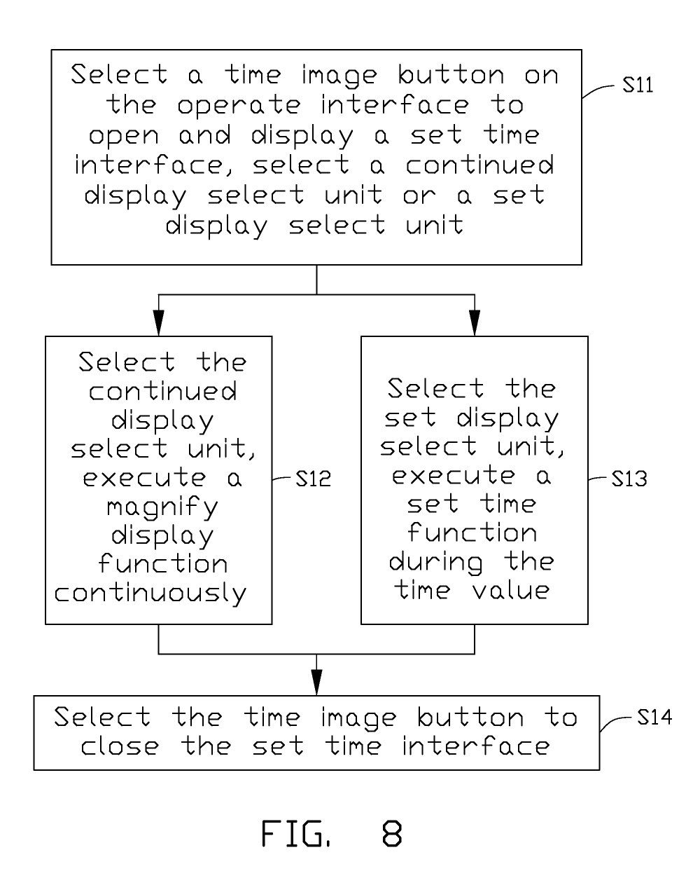

If the time image button is selected, the display time of the magnify area is set to execute steps S11 through S14, as shown in FIG. 6 and FIG. 8.

In step S11, a time image button on the operate interface is selected to open and display a set time interface, and the set time interface displays a continued display select unit or a set display select unit to be selected.

In step S12, if the continued display select unit of the set time interface is selected, a magnify display function is executed continuously.

In step S13, if the set display select unit of the set time interface is selected, a set time function is executed during the time value.

In step S14, the time image button is selected to close the set time interface.

It is to be understood that the disclosure is intended to illustrate rather than limit the present disclosure. Variations may be made to the embodiment of the disclosure without departing from the spirit of the present disclosure as claimed.

What is claimed is:

1. A software magnifier operate method of a machine tool, the method comprising:
selecting a magnifier image button on an operate interface to execute a software magnifier program;
selecting a first position of the operate interface for magnifying the first position into a first magnify area; and
selecting a second position of the operate interface for magnifying the second position into a second magnify area and closing the first magnify area simultaneously.

2. The method as claimed in claim 1, further comprising:
selecting the magnifier image button to close the software magnifier program.

3. The method as claimed in claim 1, wherein the first position and the second position are different positions of the operate interface.

4. The method as claimed in claim 1, wherein the first position and the second position each display a plurality of different parameter values which change in real time.

5. The method as claimed in claim 1, further comprising:
selecting a third position of the operate interface and closing the second magnify area simultaneously; and
magnifying the third position into a third magnify area.

6. The method as claimed in claim 5, wherein the third position is any position of the operate interface.

7. The method as claimed in claim 6, wherein the third position displays a plurality of different parameter values which change in real time.

8. The method as claimed in claim 5, further comprising the following steps:
selecting a time image button on the operate interface to open and display a set time interface, selecting a continued display select unit of the set time interface or a set display select unit of the set time interface;
executing continuously a magnify display function of the magnify position before the next position is selected, if the continued display select unit is selected; and
executing the magnify display function of the magnify position during a time value, if the set display select unit is selected.

9. The method as claimed in claim 1, further comprising:
selecting a time image button on the operate interface to open and display a set time interface, selecting and displaying a continued display select unit or a set display select unit;
executing continuously a magnify display function of the magnify position before the next position is selected, if the continued display select unit is selected; and
executing the magnify display function of the magnify position during a time value, if the set display select unit is selected.

10. The method as claimed in claim 9, further comprising the following step:
selecting the time image button to close the set time interface.

11. A machine tool, comprising:
an input unit for receiving an input instruction; and
a control unit for executing or closing a window magnify function according to the input instruction;
wherein by executing the window magnify function, the control unit magnifies a first position of an operate interface of a display unit into a first magnify area, if the first position is selected; the control unit magnifies a second position of the operate interface into a second magnify area and closes the first magnify area, if the second position is selected.

12. The machine tool as claimed in claim 11, wherein the first position and the second position each display a plurality of different parameter values which change in real time.

13. The machine tool as claimed in claim 11, wherein the display unit is a touch control display.

14. The machine tool as claimed in claim 11, wherein the first position and the second position are at different positions of the operate interface.

15. The machine tool as claimed in claim 11, wherein the control unit magnifies a third position into a third magnify area and closing the second magnify area, if the third position is selected.

16. The machine tool as claimed in claim 15, wherein the third position is at any position of the operate interface.

17. The machine tool as claimed in claim 15, wherein the third position displays a plurality of different parameter values which change in real time.

18. The machine tool as claimed in claim 11, wherein the control unit executes or closes a magnify display function according with the input instruction.

19. The machine tool as claimed in claim 18, wherein the display unit displays a set time interface to display a continued display select unit and a set display select unit, if the control unit executes the magnify display function.
